(19) United States
(12) Patent Application Publication
(10) Pub. No.: US 2006/0185521 A1
(43) Pub. Date: Aug. 24, 2006

(54) Coffee maker

(76) Inventors: J. Scott Publicover, Boise, ID (US); Mark W. Publicover, Saratoga, CA (US)

Correspondence Address: EDWARD S. SHERMAN, ESQ., 3554 ROUND BARN BLVD., SUITE 303, SANTA ROSA, CA, 95403, US

(21) Appl. No.: 11/347,074

(22) Filed: Feb. 2, 2006

Related U.S. Application Data
(60) Provisional application No. 60/650,313, filed on Feb. 4, 2005.

(51) Int. Cl. A47J 31/00

(52) U.S. Cl. 99/279

(57) ABSTRACT

A coffee maker devices comprises a thermally insulated bottled that is threadably connected to a coffee grinder at it bottle surface. A press filter is adapter for insertion into the bottle such that coffee beans freshly ground in the grinder can be steeped with hot water in the bottle to provide freshly brewed coffee on demand.

### CROSS REFERENCE TO RELATED APPLICATIONS

The present application claims priority to the U.S. provisional application having Ser. No. 60/650,313 entitled “Coffee maker”, and filed on Feb. 4, 2005, which is incorporated herein by reference

### BACKGROUND OF INVENTION

The present invention relates to a device and method for both grinding coffee beans and preparing fresh coffee.

Many people enjoy the improved flavors and aromas associated with freshly brewed coffee, in particular over instant coffee or coffee that has been brewed but loses freshness or flavor while sitting in a thermally isolated bottle. Prior methods of making fresh coffee involve providing a supply of hot water to freshly ground beans. Such devices are well known, but are not portable.

Further, they require a source of electrical power.

It is therefore a first object of the present invention to provide an improved portable device for the grinding of coffee beans and the brewing of coffee, tea and the like.

It is another object that the device be capable of storing and dispensing additional condiments such as sweetner, cream and the like.

It is a further object that the device be capable of containing or connecting to a portable power supply to operate an integrated grinder or heating element.

### SUMMARY OF INVENTION

In the present invention, the first object is achieved by providing a thermally insulated bottle having a press filter operative there within.

A second aspect of the invention is characterized in that the thermally insulated bottle includes means for storing and freshly grinding coffee beans selectively detachable there from.

The above and other objects, effects, features, and advantages of the present invention will become more apparent from the following description of the embodiments thereof taken in conjunction with the accompanying drawings.

### BRIEF DESCRIPTION OF DRAWINGS

FIG. 1 is a cross-sectional elevation of a first embodiment of the coffee making device.

FIG. 2 is a cross-sectional elevation of a second embodiment of the coffee making device.

FIG. 3 is a cross-sectional elevation of a third embodiment of the coffee making device.

FIG. 4 is a cross-sectional elevation of a fourth embodiment of the coffee making device.

FIG. 5 is a perspective view of the portion of the stem that attached to the filter in an alternative embodiment, wherein the cross-sectional elevation of the filter is included

FIG. 6 is a cross-sectional elevation of an alternative embodiment of the lid.

### DETAILED DESCRIPTION

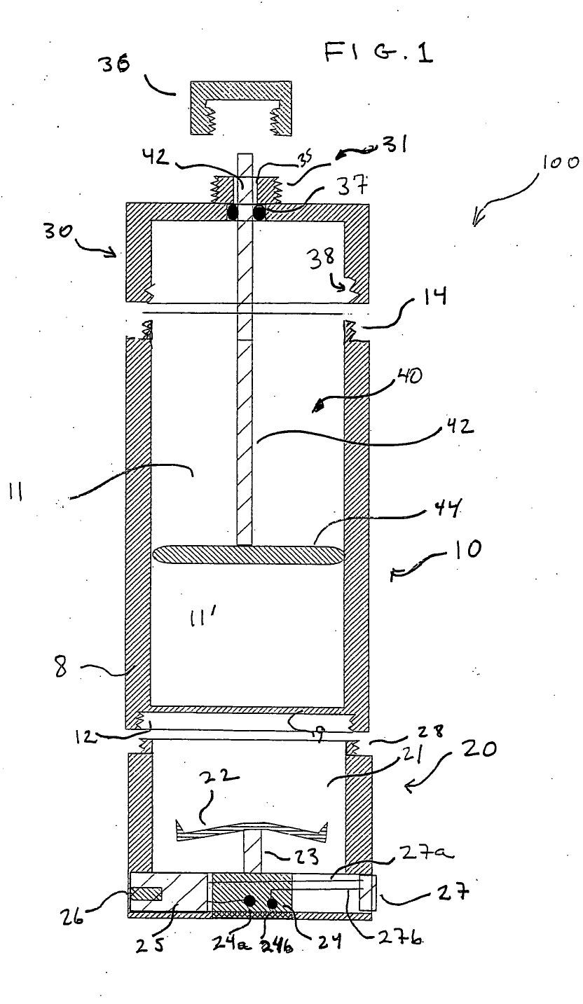

Referring to FIGS. 1 through 3, wherein like reference numerals refer to like components in the various views, there is illustrated therein a new and improved coffee maker, generally denominated 100 herein.

In accordance with the present invention, FIG. 1 illustrates coffee making device 100 as a cross-sectional elevation. The coffee making device 100 comprises thermally insulated bottle 10, a grinder 20 and lid 30 and filter element 40 and a battery or portable power source. Filter element 40 is a press filter having a stem 42 and disk filter 44. Thermally insulated bottle 10 has insulated sidewalls 8 and bottom 9, being adapted to stores hot water in substantially circular cavity 11. Coffee beans are stored in grinder 20. When the lid 30 is removed from thermally insulated bottle 10, all or a substantial portion of the diameter of cavity 11 is exposed. Thermally insulated bottle 10 has an externally threaded upper rim 14. The insulated walls and bottom of bottle 10 are optionally provided by at least one of a vacuum sealed gap, a gap filled with a thermally insulating material or a thermally insulated material that provides the mechanical strength.

Grinder 20 has upper concentric threads 28, which mate with lower concentric threads 12 of thermally insulated bottle 10. Thus, attaching grinder 20 to thermally insulated bottle 10 defines a sealed cavity 21 for storing and grinding coffee beans when the user wishes to prepare fresh coffee. Wall of grinder 20 is preferably formed of a transparent plastic material, such as polycarbonate, such that the user can quickly determine that the device 100 has been loaded with coffee beans, or that the beans have already been ground to the desirable texture. Alternatively, the sidewalls of the grinder 20 may be thermally insulating, in a similar manner to thermally insolated bottle 10.

Grinder 20 has a cavity 21 with a rotating blade 22 drive via shaft 23 by motor 24. Motor 24 is powered by either battery 25 or an external power source connected at power socket 26. The grinder 20 is operated by switch 27.

Switch 27 preferably includes a safety interlock that prevents actuation except when the grinder 20 is attached to the bottom of thermally insolated bottle 10 via threads 28. Electrical contact between the battery leads and the motor is made at electrical contacts 24a and 24b, with the current to power motor 24 being carried by wire 27a from battery 25 to switch 27, before continuing via wire 27b to contact 24b.

Lid 30 includes has a threaded outlet stem 31 at its upper surface. Lid 30 is attached to the top of thermally insulated bottle 10 via threads 33. Threaded outlet stem 31 has a concentric central bore 35. The central bore 35 of stem 34 is sealed by threaded cap 36. When the stem of press filter is inserted into central bore 35 and is sealed by O-ring 37 or the like. The bottom of lid 30 includes a rim with internal threads 38. Thus, lid 30 seal the upper rim of thermally insulated bottle 10 as in internal threads 38 engage with the external threads thereof 14.

Thus, after the user prepares freshly ground beans in grinder 20, grinder 20 is detached from the bottom of thermally insulated bottle 10 such that the freshly ground beans can be poured into the hot water in cavity 11. However, first lid 30 and attached filter element 40 is removed via the upper threaded connection of thermally insulated bottle 10. Next after, the ground coffee has steeped in the hot water for the desired period of time, the filter disk 44 is pushed downward, toward bottom surface 9, to separate the coffee grinds from the fresh coffee, which is then ready for consumption and can be poured from rim 14. Alternatively, filter assembly 40 can be removed such that coffee can be poured though the central bore 35 of outlet stem 33.

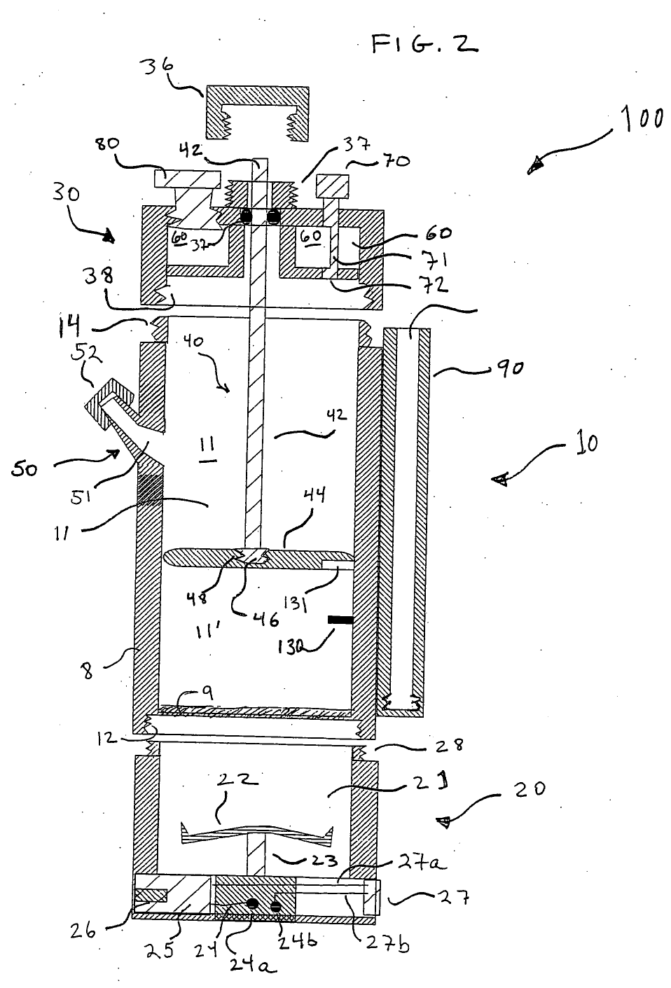

In another embodiment, shown in FIG. 2, the device includes provisions for detaching the filter element from the filter stem, as well as storing the filter stem outside the bottle. Filter stem 42 is stored in the bore 91 of tube 90, which is attached to sidewall 8. Tube 90 preferably includes internal threads 93 for receiving threaded end 46 of stem 42

Coffee maker 100 in FIG. 2 also includes a pouring spout 50. Pouring spout 50 has bore 51 leading to the substantially cylindrical cavity 11, which is sealed externally by cap 52.

While the coffee maker 100 in FIG. 2 can be used like that of FIG. 1, wherein the ground coffee is pressed down towards the bottom of thermally insulated bottle 10, the preferred method of use is to draw the coffee grounds upward that is pressing them against the lower surface external surface 60a of compartment 60. Thus, after the coffee is brewed in substantially cylindrical cavity 11, the filter and coffee grounds can be drawn upper and away from the fresh coffee, thus limiting the flavor extraction from the coffee grinds to the desired level.

Filter disk is readily detached from stem 42 after the bottom of filter disk 44 reached engaging pin 130 as stem 42 is depressed downward. Pin 130 engages slot 131 in the bottom of filter disk 44, thus preventing further rotation thereof Thus rotating of stem 42 unscrews threaded end 46 from mating threads 48 in the upper surface of filter disk 44.

Filter disk 44 is conveniently stored in or between the grinder 20 and thermally insulated bottle 10, or may be placed in a separate compartment (not shown) that attached to the bottom of the grinder 20.

The coffee maker of FIG. 2 also includes a compartment 60 for storing coffee additives, such as cream, milk, sugar and the like. Compartment 60 is preferably a concentric disc disposed about central bore 35. Compartment 60 is filled via screw portal 80. Liquid can be deposited directly into the coffee stored in cylindrical chamber 11 by external knob 70 or alternatively, the liquid can be deposited externally, into a cup, for example. Knob 70 has partial shaft 71 attached to the lower portion that penetrates into compartment 60. While the upper and lower portions of shaft 70 have circular cross section, the middle of shaft 71 has a smaller cross-sectional area Thus, the upper and lower portions of shaft 71 a substantial seal to retain liquids in compartment 60. However, when knob 70 is depressed or rotated to screw downward, the small cross section portion of shaft 70 provides an opening in the lower compartment, allow liquid to flow into cylindrical chamber 11 via hole 72. The walls of lid 30 that surround and define compartment 11 are thermally insulating to avoid heating the cooler milk or cream stored therein, that is until it is mixed with the brewed coffee by depressing knob 70.

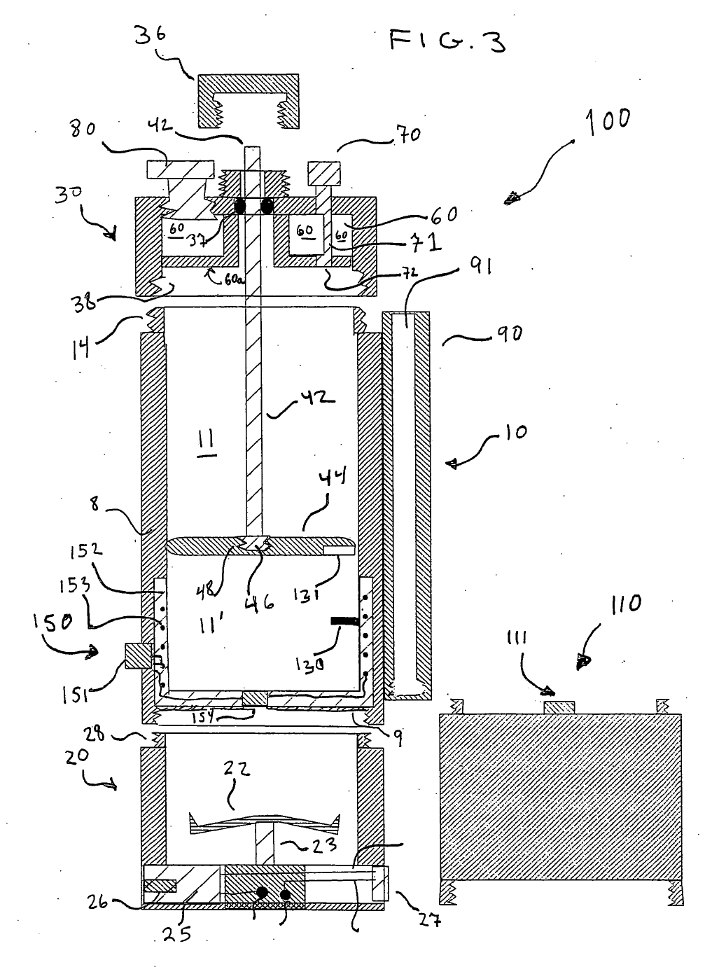

In a further embodiment of the invention, shown in FIG. 3, the device includes a heater element 150 integrated into the thermally isolated bottle. The heater element is preferably a thermally conductive block 152 having embedded heater coils 153. Heater element 150 is optionally powered by one of cylindrical battery 110, an external power source connected at socket 151, to which the heater coils are connected via a switch. The switch is preferable integrated into socket 151. Alternatively when cylindrical battery pack 110 having upper external threads 112 is screwed into he threads 12 of thermally insulted bottle 10, concentric contacts 111 in battery 110 make contact when making concentric contacts 154, energizing heating coils 153.

It should be appreciated that in many instances bayonet connections can be deployed in place of screw connection in the coffee maker device 100 and components thereof In addition, any of the aforementioned connections between the components of device 100 that need not be fluid tight are adaptable to a wide range of latch mechanisms known to one of ordinary skill in the art.

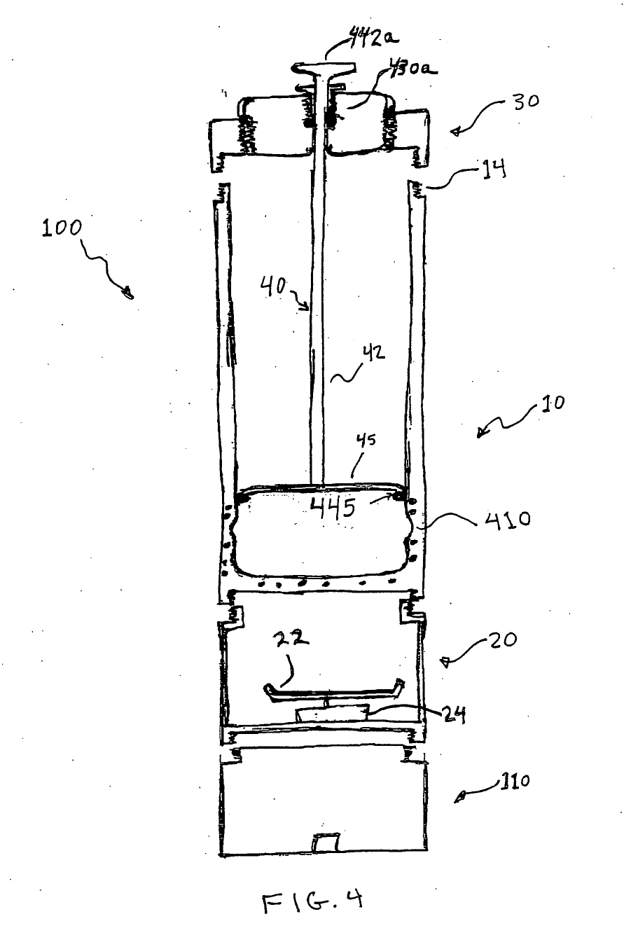

FIG. 4 shows another alternative embodiment of the coffee maker 100. Filter disk 44 has a coiled spring 445 around the periphery that makes contact with the interior walls of the thermally insulated bottle 10. The walls of the thermally insulated bottle 10 also include a concave peripheral bulge 410 for receiving springs 445 and temporally latching the filter disk and stem so that stem 42 can be removed as illustrated and described in FIG. 2 and FIG. 3.

The lid 30 includes a stem top 442a that screws into a threaded recess 430a in the lid 30. The lid 30 in turn screws into mating threads of thermally insulated bottle 10.

The stem 42 is connected to the filter element 45 such that, rather than pushing the grinds downward, the grinds are pulled upward so that they no longer need reside in the fluid where they can continue to affect the taste of the hot beverage. The lid 30 can also be shaped to allow the filter 45 to snap fit into the lid 30.

The stem 42 can be unscrewed or disengaged from the bottom of the filter/filter housing and pushed back into the container. The stem top or handle 42a is alternatively designed to attach and detach from the upper end of the stem. For example, the stem top can screw onto the stem end in a manner that synchronizes it with the screwing the container lid on and off. Alternative embodiments for removing and attaching either the filter or the stem top or handle include a snap fitting that uses a spring to urges ball bearing to engage and latch with respect to a mating recess in either the filter or the stem.

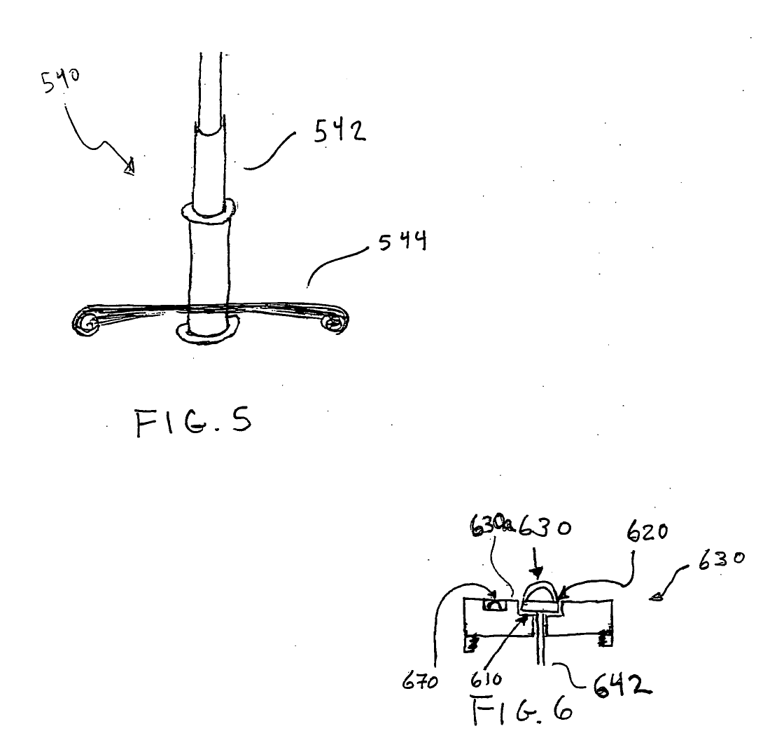

FIG. 5 is a perspective view of the portion of the stem that attached to the filter in an alternative embodiment, wherein the cross-sectional elevation of the filter is included. Stem 542 includes a plurality of slidably engaging tubes so that is can collapse telescopically into itself, as well as and back into the upper part of the container such that there is no need to disengage it from the bottom of the filter 544. The stem and filter assembly is optionally deployed with any of the alternative embodiments shown in FIG. 1-4. An alternative filter and stem assembly is disclosed in U.S. Pat. No. 5,887,510, which is incorporated herein by reference.

Any of the embodiments shown in FIG. 14 may include an auxiliary heating element that is incorporated in the stem 42 and/or a portion of the filter element 44 or 45, as well as around in the interior walls or bottom of container 10. Such a heating element can be a thermostatically controlled heating element to heat water to the desired temperature. Alternatively, the heating element may be a positive temperature coefficient (PTC) self-limiting heating element, such heating elements are disclosed in U.S. Pat. No. 4,849,611, which is incorporated herein by reference.

FIG. 6 is a cross-sectional elevation of an alternative embodiment of the lid. The switch 670 to turn on/off the heating element in the stem/filter is inset or flush mounted Battery is optionally disposed within the lid. Further the top of the 620 and a pivoting half ring handle 630 are optionally disposed in a configuration flush with upper surface 630a of lid 630 for safety and ease of handling. Further, to the extent that lid 630 also includes an integrated battery the electrical contact to heater wires in stem 642 is optionally made at inset surface 610, when the top of handle 620 is fully inserted into lid 630, having electrical contact terminals disposed therein.

Alternatively, a battery can be screwed, pressed or bayonet mounted to the lid when it is desired to heat the water or brewed coffee. Preferably an indicator light shows that current is flowing to the resistive heating element. In addition a thermometer or ready light can be used to indicate if the liquid has reached the desired temperature

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

1. A coffee making device, comprising:
a) a substantially cylindrical thermally insulated bottle having an inner cavity of a first diameter, and operative to be opened across the first diameter at the rim thereof,
b) a coffee grinder adapted for engagement to said thermally insulated container to define a cavity for storing and grinding coffee beans,
c) a filter having a vertical stem and a substantially circular filter plate of about said first diameter,
d) wherein said filter is adapted to vertically translate within said thermally insulated bottle after ground coffee is mixed with hot water stored therein.
